(19) United States
(12) Patent Application Publication
(10) Pub. No.: US 2015/0352752 A1
(43) Pub. Date: Dec. 10, 2015

(54) AN AQUEOUS -SOLVENT BASED PROCESS FOR CONTINUOUS MANUFACTURING OF SUPPORTED ION SELECTIVE MEMBRANES

(71) Applicant: General Electric Company, Schenectady, NY (US)

(72) Inventors: Russell James MACDONALD, Westborough, MA (US); Harikrishnan RAMANAN, Singapore (SG)

(73) Assignee: General Electric Company, Schenectady, NY (US)

(21) Appl. No.: 14/760,676

(22) PCT Filed: Jul. 19, 2013
(86) PCT No.: PCT/US13/51212

§ 371 Date: Jul. 13, 2015

Related U.S. Application Data
(63) Continuation-in-part of application No. PCT/US2013/021729, filed on Jan. 16, 2013.

(51) Int. Cl. B29C 39/14; C08J 5/22

(52) U.S. Cl. CPC B29C 39/14; C08J 5/22; B29K 2263/00

(57) ABSTRACT

A membrane, for example an ion exchange membrane, is made by preparing a curable liquid using at least one aqueous solvent. The curable liquid is continuously cast onto a substrate to form a membrane precursor. The membrane precursor is continuously cured to form a membrane. Optionally, the curable liquid may be made by mixing a water soluble aliphatic sulfonic acid monomer with a pair of crosslinking monomers and a water soluble free-radical generating catalyst. Optionally, the method may include one or more steps of processing the membrane.

### CROSS-REFERENCE TO RELATED APPLICATIONS

This is a national stage application under 35 U.S.C. §371(c) of prior-filed, co-pending, PCT application serial number PCT/US2013/051212, filed on Jul. 19, 2013, which claims the benefit of priority from PCT Application No. PCT/US2013/021729, filed on Jan. 16, 2013. These applications are incorporated herein in their entirety.

### BACKGROUND

U.S. Pat. No. 5,264,125, entitled Process for Manufacturing Continuous Supported Ion Selective Membranes Using Non-Polymerizable High Boiling Point Solvents, describes a process for making a supported ion exchange membrane. The process comprises forming a sandwich of a substrate and a pliable film on each face of the substrate. The films extend beyond the side edges of the substrate. The edges of the films are sealed together to form a pocket containing the substrate. Subsequently, the sandwich is pulled between a pair of squeeze rolls. A liquid is added to the pocket above the squeeze rolls to form a pool of the liquid above the squeeze rolls and between the films. The liquid wets the substrate and fills apertures in the substrate before the sandwich passes through the squeeze rolls. From the squeeze rolls, the sandwich passes through a set of means, for example heaters, for curing the liquid. Polymerizable components in the liquid are polymerized thereby forming a reinforced polymer sheet. The sandwich proceeds through a set of knives which remove the seals at the edges of the sandwich and through a pair of rollers which remove the films from the polymer sheet. The polymer sheet is then an ion exchange membrane.

### SUMMARY

A method described in this specification is used for making ion exchange membranes. The method comprises the steps of preparing a curable liquid with an aqueous solvent; casting a membrane precursor; and curing the membrane precursor to form a membrane. The step of casting the membrane comprises introducing the curable liquid into a film pocket and wetting a substrate with the curable liquid. In an embodiment, the steps of casting and curing operate continuously. Optionally, the curable liquid may be made by mixing a water soluble aliphatic sulfonic acid monomer with a pair of crosslinking monomers and a water soluble free-radical generating catalyst. Optionally, the method may include one or more steps of processing the membrane.

### BRIEF DESCRIPTION OF THE DRAWINGS

FIG. 1 is a schematic diagram of an apparatus for manufacturing membranes.

FIG. 1A is a diagram of an example of an apparatus according to FIG. 1.

FIG. 1B is a diagram of another example of an apparatus according to FIG. 1.

FIG. 2 is a schematic flow chart of a process for manufacturing membranes.

FIG. 2A is a flow chart of an example of a process according to FIG. 2.

FIG. 3 is a graph depicting the ion exchange capacity (IEC) and water content of an ion exchange membrane vs. the mole ratio of a tertiary amine (DMAPMA) to cyclohexanedimethanol diglycidyl ether in a primary crosslinker.

### DETAILED DESCRIPTION

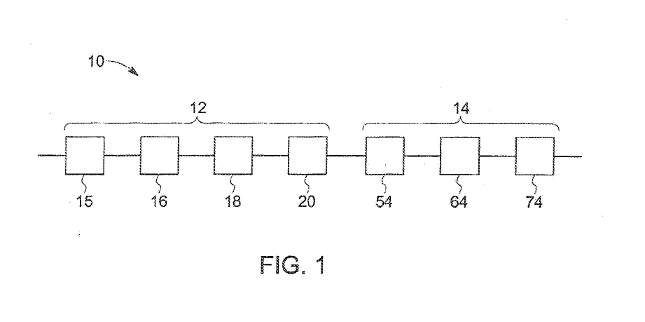

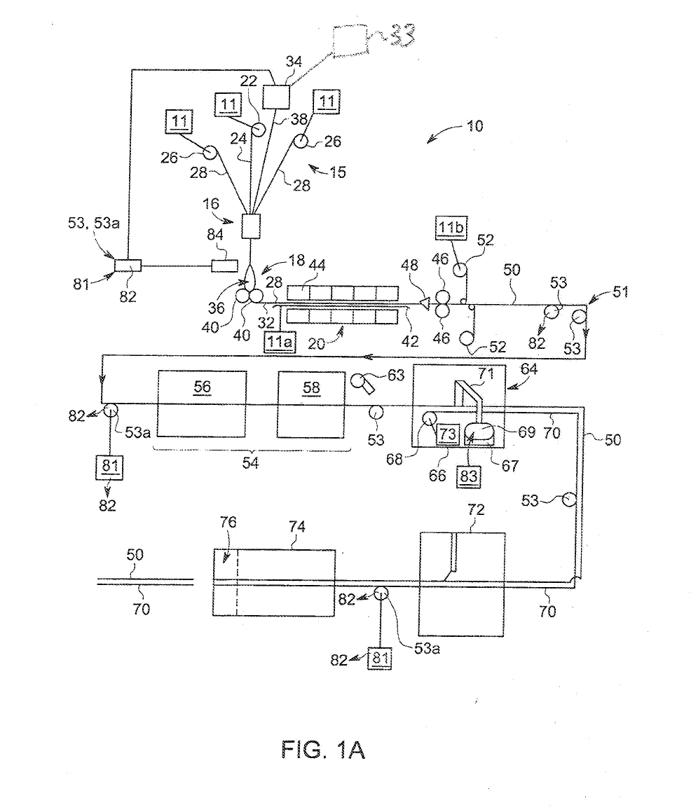

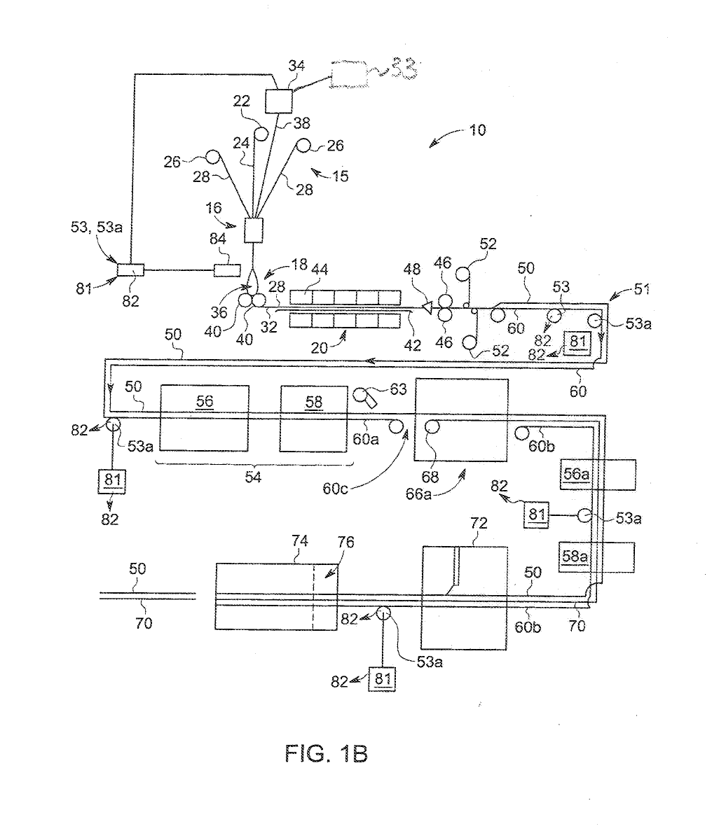

FIG. 1 is a schematic diagram of an apparatus 10 for manufacturing membranes 50. While the apparatus 10 is suitable for the manufacture of various types of membranes 50, it is, in an embodiment, used in the manufacture of ion exchange membranes. The apparatus comprises two primary sections: a casting section 12 and a processing section 14. The casting section 12 comprises a roll section 15, a film sealing section 16, a nip section 18 and a curing section 20. The casting section 12 is similar to the system described in U.S. Pat. No. 5,264,125 to MacDonald et al., which is incorporated herein by reference.

The processing section 14 comprises one or more of a conditioning section 54, a leak test section 64, a cutting section 74 and a conveyor system 51, which is shown in FIG. 1A.

In the example of FIG. 1A, the roll section 15 includes a substrate feeder 22 that feeds a sheet of substrate 24 into the remainder of the apparatus 10. The substrate 24 is alternatively called a base material or a support layer and various suitable examples are commercially available. A substrate 24 is typically made up of one or more polymers, for example acrylic, polypropylene or polyester that can be extruded into yarns and woven into a fabric or combined into a non-woven fabric. Another example of a suitable substrate is a microporous polyethylene film. Optionally, the substrate 24 can be provided on rolls in the substrate feeder 22.

The roll section 15 also includes two film feeders 26 that each feed a sheet of film 28 into parts of the remainder of the apparatus 10. The films 28 can be prepared from any type of material that is generally impermeable to volatile components and to a curable liquid 36 and allows the membranes 50 to be separated from the films 28. For example, the films 28 may be made of thermoplastic polymer resins of the polyester family such as polyethylene terephthalate. The films 28 may be between 0.001 inches and 0.010 inches thick, or other sizes. Optionally, the films 28 can be provided on rolls in the film feeders 26.

The substrate feeder 22 and the film feeders 26 may be passive or the feeders 22, 26 may apply a resistance to unrolling. Alternatively, feeders 22, 26 are powered by one or more motors 11 to encourage unrolling and to facilitate a desired line speed and tension of the membrane 50 as it is conveyed through the apparatus 10. Optionally, other features that are described below contribute to maintaining the desired line speed and tension.

The film feeders 26 can provide a quantity of the same film 28. Optionally, each film feeder 26 may provide a different film 28.

The substrate feeder 22 and the film feeders 26 are arranged to feed the substrate 24 between the two films 28. The resulting arrangement of the substrate 24 and the films 28 travels through the apparatus 10 with a respective longitudinal centerline of the substrate 24 and the films 28 moving essentially in a single plane. The substrate 24 and the films 28 may be brought into a desired spacing or alignment relative to each other by passing over one or more devices, such as rollers, belt, guides or other suitable devices (not shown).

The substrate 24 and the films 28 pass from the roll section 15 to the film sealing section 16. The film sealing section 16 may include an edge sealing device (not shown) that seals the edges of the films 28 together. In an embodiment, the films 28 are sealed beyond the edges of the substrate 24 that is located between the films 28. The edge sealing device provides an energy source, for example a heater or ultrasonic welder, to melt the edges of the films 28. The edge sealing device can also include a presser (not shown) for pressing the melted edges together. The pressing step may be performed after or during the step of melting the edges. In another example of the film sealing section 16, the sealing of the edges may be achieved by using pressure sensitive adhesive or hot melt adhesive that is applied along the edges of a polyester film and pressing the edges together rather than melting the edges of the films 28.

Sealing the edges of the films 28 together forms a pocket of film 28 with the substrate 24 located between the films 28. The pocket of film 28 may also be referred to as a film pocket, a substrate and a film sandwich. The film pocket facilitates the substrate wetting process that occurs in the nip section 18, to be described below. However, in a modified or other wetting process, the film sealing section 16 may be omitted.

The nip section 18 includes a liquid feeder 34 that provides the curable liquid 36 into the film pocket, between the films 28, to wet the substrate 24. The wetted substrate 24 is also referred to as a membrane precursor 32. The liquid feeder 34 comprises a mixing tank 33 where chemical components of the curable liquid 36 are mixed. The mixing tank 33 may include a means for mixing or blending the components of the curable liquid 36, or not. Optionally, a reservoir (not shown) may be used to store the curable liquid 36 after the chemical components are mixed. As a further option, the curable liquid 36 may be deoxygenated by spraying into a vacuum chamber (not shown) with a pressure of about 2 mm Hg (absolute). One or more feeding tubes 38 may continuously feed the curable liquid 36 from the mixing tank 33, or the reservoir or the vacuum chamber, to wet the substrate 24. The feeding tubes 38 extend from the liquid feeder 34, past the edge sealing device, and terminate above a pair of nip rollers 40. Although FIG. 1A depicts the liquid feeder 34 as shown above the roll section 15, various other orientations are possible.

The curable liquid 36 can collect in a pool above the pair of nip rollers 40. The space between the nip rollers 40 is set to produce a membrane precursor 32 of a desired thickness. The feeding tubes 38 can temporarily provide an amount of the curable liquid 36 that exceeds the amount of curable liquid 36 that travels with the substrate 24 past the nip rollers 40. The excess curable liquid 36 pools above the nip rollers 40, which permits the continuous wetting of the substrate 24 as it travels through the nip section 18.

Continuous casting of the membrane precursor 32, caused by the continuous wetting of the substrate 24 with the curable liquid 36, permits a continuous production of the membrane 50.

The curable liquid 36 is prepared by mixing, or blending, a curable liquid with an aqueous solvent. The curable liquid may comprise vinyl-containing monomeric electrolytes. In an embodiment, the aqueous solvent is water. As described further below, various curable liquids 36 that are produced using aqueous solvents are suitable for use in the apparatus 10 to produce the membrane precursor 32.

The curable liquid 36, the substrate 24 and the films 28 are selected to be compatible with each other. Optionally, other chemicals such as diluents and polymerization initiators may be a chemical component of the curable liquid 36 or added to the curable liquid 36 within the liquid feeder 34 or added into the pool of curable liquid 36 above the nip rollers 40. For example, the diluents and polymerization initiators may be as described in U.S. Pat. No. 4,374,720 to MacDonald, which is incorporated herein by reference.

In one option of the apparatus 10, the height of the pool of excess curable liquid 36 above the nip rollers 40 can be controlled to adequately wet the substrate 24 and form the membrane precursor 32. For example, the height of the curable liquid 36 above the nip rollers 40 can be monitored by a sensor 84 that provides pool height information to a controller 82. In an embodiment, the controller 82 includes one or more programmable devices such as a processor or microprocessor, computer, Field Programmable Gate Array, or programmable logic controller (PLC). Alternatively or additionally, the controller 82 may comprise one or more non-programmable control elements, such as a timer or pneumatic or electric circuit, capable of implementing a sequence of operations.

The controller 82 compares the pool height information to a pre-set height value or range and determines any difference between the height information and the pre-set height value or range to generate a pool height error signal. Based upon the pool height error signal, the controller 82 can command the liquid feeder 34 to provide more or less curable liquid 36. For example, the pre-set height value or range can be between about 2 and about 15 cm. The pre-set height value or range can be selected to provide sufficient contact time between the substrate 24 and the curable liquid 36 to create the membrane precursor 32. Optionally, the liquid feeder 34 further includes a pumping system that delivers curable liquid 36 based upon commands received from a controller 82.

The membrane precursor 32 and the films 28 pass through the nip rollers 40 and then move to the curing section 20. The membrane precursor 32 and the films 28 can be supported on a continuous or segmented platform 42, which conveys the membrane precursor 32 and the films 28 through the curing section 20. Optionally, the platform 42 is moved by a motor 11a. One or more curing devices 44 produce conditions in the curing section 20 that support a polymerization reaction by which the curable liquid 36 forms a solid polymer. The polymerization reaction transforms the membrane precursor 32 into the membrane 50. For example, the curable liquid 36 may be cured by heat or by infrared, microwave, ultraviolet, or other forms of radiation. In one embodiment, the membrane precursor 32 may be heated to a temperature of from about 40° C. to about 250° C. to initiate and maintain the polymerization reaction. The curing section 20 may be in the range of about 2 to about 20 meters long. The residence time in the curing section 20 may be in the range of about 4 to about 40 minutes, or longer. These temperatures and times may vary depending on the curable liquid 36 used and the polymerization reaction. Further, the temperature within the curing section 20 may be the same, or the curing section 20 may have sub-sections with purposely different temperatures.

Upon leaving the curing section 20, the membrane 50 and the films 28 are conveyed through the processing section 14. The processing section 14 comprises one or more sections, such as a conditioning section 54, a leak test section 64 and, a cutting section 74, and the conveyor system 51. The conveyor system 51 includes a series of rollers 53 that convey the membrane through the sections of the processing section 14.

The processing section 14 includes a second pair of nip rollers 46 that receives the membrane 50 and the films 28 following the curing section 20. Optionally, a knife 48 is located before, or after, the second pair of nip rollers 46 for trimming the edges of the films 28. The processing section 14 also includes film rollers 52 that separate the films 28 from the membrane 50. The film rollers 52 peel the films 28 from the membrane 50 and roll them up. One or more of the film rollers 52 can be driven by one or more motors 11b to facilitate moving the membrane precursor 32, the membrane 50 and the films 28 through the casting section 12.

The processing section 14 includes a conditioning section 54 that treats the membrane 50 to reduce an amount of residues in the membrane 50. The residues are components of the membrane precursor 32 that do not participate, either partially or fully, in the polymerization reaction. The residues may also be referred to as polymerization reaction residues. The residues can be distributed evenly, or unevenly, throughout the membrane 50. The residues may comprise monomers, oligomers, polymers, solvents, unreacted reactants, polymerization initiators, catalysts or a combination thereof. The residues may also comprise various ions, chemicals or combinations thereof. For example, the residues may include, but are not limited to, various ion species such as sulfonate ions, chloride ions, iodide ions, bromide ions, lithium ions, lithium hydroxide ions, sodium ions, hydrogen ions or a combination thereof.

The conditioning section 54 includes one or more conditioning tanks. Conditioning tanks can also be referred to as extraction tanks or washing tanks. Each conditioning tank can be filled with water, or an aqueous solution or a solvent or some other liquid. When a conditioning tank is filled with water, the water is substantially de-ionized in an embodiment, for example with a conductivity of 50 microS/cm or less. However, water with higher conductivity may still be considered to compose a water tank. A non-water tank may also contain mostly water, but the water is mixed with another compound to modify its reaction with the membrane.

The conditioning section 54 may consist of only one non-water tank, more than one non-water tank, one or more non-water tanks positioned before or after a water tank, only one water tank, more than one water tank, one or more water tanks positioned before or after a non-water tank or other combinations of one or more conditioning tanks. In one example, a conditioning tank containing water, with a conductivity of 50 microS/cm or less in an embodiment, is used alone or as the first tank in a series of conditioning tanks. In the example of FIG. 1A, the conditioning section 54 includes two conditioning tanks, an extraction tank 56 and a washing tank 58. The extraction tank 56 can hold extraction fluids. Extraction fluids decrease the amount of residues within the membrane 50 as it is conveyed through the extraction tank 56 by the conveyor system 51. The extraction fluids may comprise ionic solutions, inorganic ionic solutions, non-ionic solutions, inorganic non-ionic solutions, substantially pure inorganic solvents, inorganic solutions with additives or a combination thereof. For example, the extraction tank 56 may contain a sodium chloride solution, a bicarbonate solution, a citric acid solution, a lactic acid solution, an acetic acid solution, a hydroxide solution, a solution containing one or more surfactants or a combination thereof.

The pH of the extraction solutions can vary with its intended purpose. For example, if it is desired to reduce any basic residues, the pH of the extraction solutions can be maintained in a range of about 2 to 4. This acidic pH range can be achieved and maintained by the addition of citric acid, acetic acid or other suitable acid solutions. If it desired to reduce any acidic residues, the pH of the extraction solutions can be maintained in a range of 9 to 13, for example, by the addition of bicarbonate.

The extraction tank 56 can be of a variety of shapes and dimensions. The conveyor system 51 conveys the membrane 50 through the extraction tank 56 either partially or fully submerged in the extraction fluids. The conveyor system 51 can convey the membrane 50 through the extraction tank 56 vertically, horizontally, on an inclined path or on a declined path, or a combination thereof. Further, the conveyor system 51 can make one or more passes through the extraction tank 56.

In an embodiment, the wash tank 58 is downstream from the extraction tank 56. The wash tank 58 contains water to wash the extraction fluids and at least some of the residues from the membrane 50. The water may replace any extracted residues within the membrane 50 and wet the membrane 50. Various types of water are suitable, including filtered water, distilled water, double distilled water, de-ionized water with conductivity of less than about 50 microS/cm, reverse osmosis permeate water and the like. Optionally, the water may be recycled through one or more steps of washing and water with a higher conductivity may be used. The water can be maintained at a pH range of about 5 to 8, and more particularly with a pH of about 7. Optionally, the pH of the water can be maintained at a higher or lower pH depending upon the pH of the extraction fluids in the extraction tank 56.

The conveyor 51 conveys the membrane 50 from the conditioning section 54 to the leak test section 64. The leak test section 64 includes a dye applicator 66 and a contrast feeder 68. The dye applicator 66 can automatically apply a dye to an upper surface of the membrane 50. The dye applicator 66 can include a dye reservoir 67, a pumping system 69 and a distribution pipe 71. The distribution pipe 71 has one or more nozzles. The pumping system 69 draws dye from the dye reservoir 67 and distributes dye through the one or more nozzles onto the upper surface of the membrane 50 as it is conveyed past the distribution pipe 71. Optionally, a leak test controller 83 can control the pumping system 69 to control the amount of dye distributed through the nozzles based upon on the speed at which the membrane 50 is conveyed past the distribution pipe 71. Optionally, one or more spreaders (not shown) may be provided downstream of the distribution pipe 71 to spread the dye evenly across the upper surface of the membrane 50. For example, the spreaders may be brushes, rubber or metal blades, sponges, or the like. As shown in the example of FIG. 1B, the leak test section includes a station 66a for housing an operator that can manually apply and evenly spread dye on the surface of the membrane 50.

The dye can be a permanganate based dye, such as dark violet dye; a methylene blue based dye; a chromate based dye, such as a red/orange dye; Erythrosin B dye or another other suitable dye that is compatible with the membrane 50. The dye can be made into a solution in a range of about 1% to about 30% weight of the dye to a volume of water (wt/v). In an embodiment, the dye is made into a solution of about 5% wt/v.

When the dye is applied to the membrane 50, the dye can enter the upper surface of the membrane 50, pass through any physical flaws in the body of the membrane 50 and exit through a lower surface of the membrane 50. The physical flaws in the membrane 50 can be spaces, gaps, holes or the like within the membrane 50 that are caused by imperfect polymerization reaction conditions, the presence of contaminants within the curable liquid 36 or various other reasons. The physical flaws in the membrane 50 can be localized phenomena or widespread throughout the membrane 50.

The contrast feeder 68 feeds a sheet of contrast material 70 into the remainder of the apparatus 10. The contrast feeder 68 can be positioned before, within or after the dye applicator 66. For example, the contrast material 70 is provided on rolls in the contrast feeder 68. In particular, the contrast feeder 68 feeds the contrast material 70 from below the membrane 50 upwards between the rollers 53 of the conveyor system 51. The sheet of contrast material 70 contacts the lower surface of the membrane 50. Any dye that passes through physical flaws in the membrane 50 will exit the membrane 50 and mark the contrast material 70 at or close to where the dye exited the membrane 50. The contrast material 70 can be made of one of various materials that provide a high visual contrast with the dye. The dye can mark the contrast material 70 in a manner that will not be significantly reduced or removed by the remainder of the processing section 14. For example, the contrast material 70 can be cloth, paper cloth, cellulose-fiber based cloth, or polypropylene and the dye may clearly mark the contrast material 70 and provide a visual indication of any portions of the membrane 50 that contain physical flaws.

The conveyor system 51 conveys the membrane 50 and the contrast material 70 from the leak test section 64 to the cutting section 74. The cutting section 74 has one or more blades to cut the membrane 50, and optionally the contrast material 70, into various desired sizes for storage and transport. The cutting section 74 includes an inspection station 76 positioned either before or after the membrane 50 is cut. Within the inspection station 76, an operator can identify any dye marked portions of the contrast material 70 that indicate regions of the membrane 50 with physical flaws. Optionally, the cutting section 74 can be automated based upon a count algorithm and the line speed of the conveyor system 51 to produce a final membrane 50 of a desired size. Alternatively, the cutting section 74 can be manually operated.

The conveyor system 51 conveys the membrane 50 through the processing section 14 by the rollers 53. While the examples of FIGS. 1A and 1B depict the conveyor system 51 as having multiple turns, this is provided for ease of depiction. For example, the conveyor system 51 could include one or more or no turns. The conveyor system 51 can be configured to meet the physical footprint requirements of the location where the apparatus 10 is installed and operating. In an embodiment, the conveyor system 51 conveys the membrane 50 as a continuous structure that extends along a path of travel from the curing section 20 through to the cutting section 74. However, other configurations are possible.

The rollers 53 are located at various points throughout the processing section 14 and support the membrane 50. The rollers 53 define the path of travel through the processing section 14. In an embodiment, the membrane 50 is conveyed in a central position, with respect to a width of the rollers 53, along the path of travel. One or more devices, such as rollers, belts or guides (not shown) can maintain the membrane 50 in the central position along the path of travel.

One or more of the rollers 53a can be actively rotated by a motor 81. Alternatively, none of the rollers 53 are actively rotated by the motor 81 and the movement of the membrane 50 through the processing section 14 is dependent upon other features of the apparatus 10. In an embodiment, at least some of the rollers 53a are actively rotated by the motor 81. Actively driven rollers 53a convey the membrane 50 at the desired line speed and the desired tension through the processing section 14. The rollers 53 that are not actively rotated by the motor 81 may be passively rotated by the membrane 50 moving along the path of travel.

The motor 81 can be a series of motors that individually drive each roller 53a. Optionally, the rollers 53a can be connected by a belt drive (not shown) that is driven by one or more motors 81. As a further option, rollers 53, 53a can be organized into localized sections with the rollers 53a of each localized section connected by a belt drive that is driven by one or more motors 81. For example, one localized roller section can convey the membrane 50 from the end of the curing section 20 through the conditioning section 54. A second localized roller section can convey the membrane 50 from the conditioning section 54 through the leak text device 64 and a third localized roller section can convey the membrane 50 through the remainder of the processing section 14. The conveyor system 51 can include any number of localized roller sections.

The motor 81 can be a servo motor, stepper motor or any other motor that can be pre-programmed or that will respond to commands from a conveyor or controller 82. When there are multiple motors 81, the multiple motors 81 can rotate all of the rollers 53a, or all of the drive belts that rotate the rollers 53a, at the same desired rate. The rate of rotation determines the line speed of the membrane 50 along the path of travel and through the processing section 14. In an embodiment, the rollers 53a rotate at the same rate to provide a consistent line speed. The line speed regulates the residence time of the membrane 50 through the conditioning section 54 and the line speed can dictate the overall production rate of the apparatus 10. Maintaining a consistent line speed also regulates the tension of the membrane 50 throughout the processing section 14. More particularly, the tension of the membrane 50 keeps the membrane 50 flat to prevent pooling of the extraction fluids and water on the upper surface of the membrane 50, which can interfere with evenly applying the dye during the leak testing. However, in a modified apparatus 10, different tensions may be used through the processing section 14 and other sections of the apparatus 10.

In one option of the conveyor system 51, the motor 81 includes a tachometer that provides rotary velocity information to the controller 82. The controller 82 compares the rotary velocity information with a pre-set rotary velocity value and generates an error signal. The pre-set rotary velocity corresponds with the desired line speed. The error signal is the difference between the actual rotary velocity and the pre-set rotary velocity value. The controller 82 mathematically transforms the error signal into a velocity adjustment signal, which is sent to the motor 81. Upon receiving the velocity adjustment signal, the motor 81 adjusts its rotary velocity. The tachometer can be one of various rotary velocity sensors or angular position sensors, for example digital sensors, contact-based sensors, magnetic-based sensors and the like.

As a further option of the conveyor system 51, one or more of the rollers 53, 53a include roller velocity sensors. The roller velocity sensors provide roller velocity information to the controller 82. The controller 82 compares the roller velocity information with a pre-set roller velocity value and generates a roller velocity error signal. The pre-set roller velocity may also correspond with the desired line speed. The error signal is the difference between the actual roller velocity and the pre-set roller velocity value. The roller velocity error signal is mathematically transformed and added to the velocity adjustment signal, which is sent to the motor 81 and the motor 81 adjusts its rotary velocity. The roller velocity sensors can be one of various rotary velocity sensors and angular position sensors, for example digital sensors, contact-based sensors, magnetic-based sensors or the like.

In the example of FIGS. 1A and 1B, the apparatus 10 allows for a continuous production and processing of a membrane 50. For example, up until being cut in the cutting section 74, the membrane 50 can be continuous with the membrane precursor 32, which is continuous with the substrate 24 as it is fed into the apparatus 10. The substrate 24 can be of sufficient tensile strength so that as the conveyor system 51 conveys the membrane 50 through the processing section 14, the upstream portions of the substrate 24, including the membrane precursor 32, can be pulled through the casting section 12 at the desired line speed. Optionally, the motors 11, 11a and 11b can be similar to the motor 81. For example, the motors 11, 11a and 11b can be programmed to run at a rotational velocity that matches the desired line speed of the conveyor system 51. Alternatively, the controller 82 can regulate the rotational velocity of the motors 11, 11a and 11 b to match the desired line speed of the conveyor system 51. Optionally, the speed at which the roll section 15 forms the film pocket, the speed at which the film sealing section 16 seals the film pocket, the speed at which the nip section 18 wets the substrate 24 to form the membrane precursor 32 and the speed at which the curing section 20 cures the membrane precursor 32 into a membrane 50 can all be substantially the same speed. The speed at which the casting section 12 casts the membrane 50 can be substantially the same speed as the speed the conveyor system 51 conveys the membrane 50 through the processing section 14.

As shown in the example of FIG. 1B, the conveyor system 51 can further comprise a platform 60 that rests on the rollers 53, 53a and supports the membrane 50 throughout the processing section 14. The platform 60 can be segmented or continuous. The rollers 53a move the membrane 50 across the platform 60 at the desired line speed. In an embodiment, the platform 60 has a first section 60a and a second section 60b. The first and second sections 60a, 60b are separated by a gap 60c that allows the contrast material 70 to be fed between the lower surface of the membrane 50 and the upper surface of the platform 60. Optionally, the platform 60 can be continuous with the platform 42 of the curing section 20.

As shown in the example of FIG. 1B, the apparatus 10 can be modular and permits various configurations of the processing section 14. For example, the processing section 14 can include one or more further extraction tanks 56a. The further extraction tanks 56a may be the same as the extraction tanks 56, or not. If the membrane 50 is made with a curable liquid 36 that produces a greater amount of residues, the further extraction tanks 56a can be provided to remove more residues. The further extraction tanks 56a can be positioned before or after the leak test section 64 and before the cutting section 74. Optionally, the further extraction tanks 56a may be accompanied by further wash tanks 58a, or not. The further wash tanks 58a may be the same as the wash tanks 58, or not. As another option, the water can be cyclically recycled between wash tanks 58, 58a, for example in a cascade flow system.

When there is more than one extraction tank 56, 56a the extraction fluids can be the same or different between the extraction tanks 56, 56a. If the extraction fluids are the same, the concentration of the extraction fluids can be the same or different between the extraction tanks 56, 56a. When there is more than one wash tank 58, 58a, the water can be the same or not between the water tanks 58, 58a.

As shown in the example of FIGS. 1A and 1B, the processing section 14 can further include a dye removal device 72 that removes any excess dye from the upper surface of the membrane 50. The dye removal device 72 comprises one or more brushes, rubber or metal blades, sponges, wipers, a blower or combinations thereof that are positioned above or beside the path of travel.

In one option of the conditioning section 54, a blower 63 is positioned at the downstream end of the conditioning section 54. The blower 63 provides a pressurized stream of air, or other suitable inert gas, to remove any residual extraction fluids and water from the upper surface of the membrane 50.

In another option of the conditioning section 54, the extraction tank 56 and the wash tank 58 each comprise a pump and circulation loop (not shown). The pump and circulation loop agitates the fluids within the respective tanks. The pump and circulation loop also withdraws and replenishes the fluids to optimize their respective conditions, such as pH, and to remove any particulate matter and other contaminants or waste from the tanks 56, 58.

In another option of the conditioning section 54, the extraction tank 56 and the wash tank 58 include a cover. The cover prevents the loss of any sprayed fluids, gaseous fluids and volatiles from the tanks 56, 58. The cover also provides thermal insulation so that a temperature regulation system (not shown) can maintain a temperature of the fluids within a range of about 0° C. to about 85° C. In an embodiment, the temperature in the tanks 56, 58 is maintained in a range of about 5° C. to 70° C.

In one option of the leak test section 64, a motor 73 actively drives the contrast feeder 68 to feed the contrast material 70. The motor 73 can receive commands from the controller 82 to match the rate at which the contrast material 70 is introduced into the leak test section 64 with the desired line speed of the membrane 50.

In one option of the conveyor system 51, the rollers 53, 53a are positioned within the extraction tank 56 and the membrane 50 makes more than one pass through the extraction fluids. For example, the rollers 53, 53a convey the membrane 50 through a series of switchbacks through the extraction tank 56. The multiple passes increase the length of the path of travel within the extraction tank 56, which increases the overall residence time within the extraction tank 56 without necessitating a larger sized extraction tank 56.

In another option of the conveyor system 51, one or more storage rollers (not shown) can be provided. For example, a storage roller may be positioned prior to the curing section 20 for collecting and storing the membrane precursor 32 and the films 28 by rolling them up. Optionally, another storage roller can collect and store the membrane 50, with or without the films 28, after the curing section 20. The storage rollers allow portions of the membrane precursor 32 and the membrane 50, as the case may be, to be moved from one location to another. For example, storage rollers can be used in a facility that does not have an adequate physical foot print to position all of the features of the apparatus 10 in close proximity to each other. The collected and stored membrane precursor 32 and membrane 50 can be introduced from the storage rollers onto a roller 53, 53a, or alternatively onto the platform 60, and then conveyed through the processing section 14.

In another option of the conveyor system 51, edge guide sensors (not shown) are positioned on both sides of the conveyor system 51 at various points along the path of travel. The edge guide sensors can detect if the membrane 50 shifts from the central position. When such a shift is detected, the edge guide sensors generate a misalignment signal that is sent to the controller 82. Upon receiving the misalignment signal, the controller 82 generates an alignment signal that is sent to one or more alignment members that are positioned along the path of travel. Upon receiving the alignment signal, the alignment members can adjust the position of the membrane 50 back to the central position. When the membrane 50 is back in the central position, the edge guide sensors stop generating the misalignment signal and the controller 82 stops generating the alignment signal. For example, the edge guide sensors can be optical sensors, touch sensors or the like. The alignment members can include guides, gates or adjustable rollers that can laterally alter the course of the membrane 50 as it is conveyed along the path of travel.

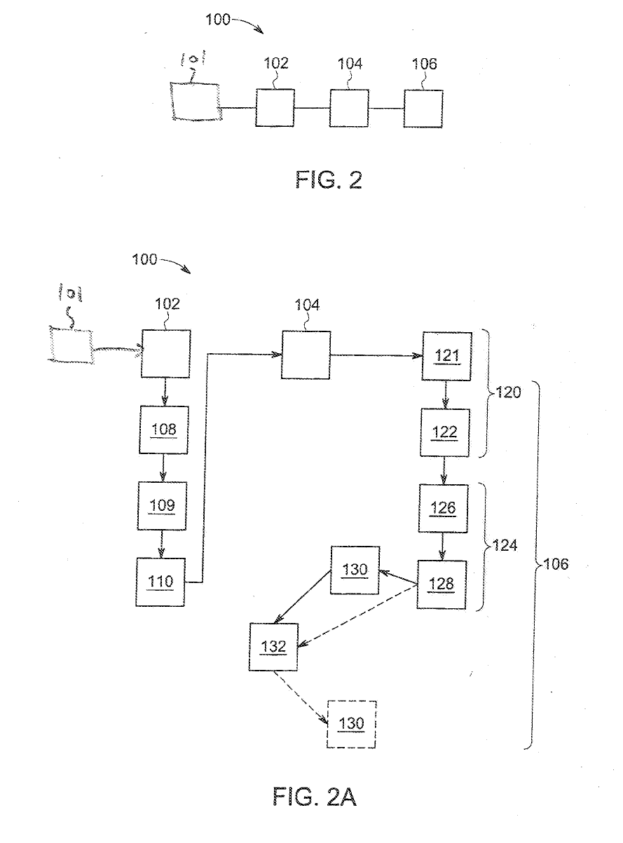

FIG. 2 is a schematic flow chart of a method 100 for manufacturing membranes 50. The method 100 comprises the steps of preparing a curable liquid 101, casting a precursor 102, curing the precursor to form a cured membrane 104 and processing the cured membrane 106. In an embodiment, the casting and curing steps operate continuously. In an embodiment, the cured membrane is conveyed through at least the processing step 106.

The step of preparing a curable liquid 101 uses aqueous solvents. For example, U.S. Pat. No. 4,617,321 to MacDonald, which is incorporated herein by reference, disclosed a process for preparing examples of the curable liquid 36. This process uses water as a solvent and mixes water soluble aliphatic sulfonic acid monomers with a pair of crosslinking monomers and a water soluble free-radical generating catalyst. This example of the curable liquid 36 is subjected to a simultaneous polymerization and crosslinking reaction to form cation exchange polymers.

Suitable water-soluble aliphatic sulfonic acid monomers include 2-acrylamido-2-methylpropane sulfonic acid (also available under the trademark AMPS), sulfoethylmethacrylate, or sulfopreopylmethacrylate.

U.S. Pat. No. 4,617,321 to MacDonald discloses suitable crosslinking monomers that are selected from either acrylamide and N-methylolacrylamide or methacrylamide and N-methylolmethacrylamide.

The water soluble free-radical generating catalyst, which catalyzes the polymerization reaction, may be a peroxide catalyst or an azo catalyst. Examples of water-soluble peroxide catalysts include 2,4-pentanedione peroxide, hydrogen peroxide, potassium persulfate and the like. Examples of water-soluble azo catalysts include 2,2′-azobis(2-amidinopropane)dihydrochloride (also available under the trademark V-50) and 2,2′-azobis(N,N′-dimethyleneisobutyramidine)dihydrochloride. These catalyst compounds, which serve as free radical initiators, contain an —N═N— group (azo) or —O—O— group (peroxide) attached to aliphatic carbon atoms, of which at least one is tertiary. The catalyst can be added in an amount of 0.01% to 2% of the weight of the monomers.

U.S. Pat. No. 4,617,321 disclosed an example process whereby 1567 grams of 2-acrylamido-2-methylpropane sulfonic acid were added to a solution of 2016 ml of NMA-special. NMA-special is a commercially available, 48% aqueous solution of equimolar amounts of N-methylolacrylamide and acrylamide. When the solution homogenized, a solution of 40 grams of 2,2′-azobis(2-amidinopropane)dihydrochloride, dissolved in 416 ml of water, was added. This process produces an example of the curable liquid 36.

This example curable liquid taught by U.S. Pat. No. 4,617,321 was poured into an 11″×13″×2″ rectangular tray into which a sandwich of glass plates and 20 mil thick modacrylic cloth were contained. The tray was heated for two hours at 80° C. which resulted in the cloth being impregnated with a polymerized resin, referred to as a membrane. The resulting membrane was placed in an aqueous sodium bicarbonate solution and analyzed. The analysis revealed the following properties of the membrane:

Mullen Burst=140 psi;

Thickness=0.054 cm;

Resistivity=13.0 ohm-cm²;

Water Content=45.6%; and

Capacity=2.4 milliequivalents Na⁺ per gram of dry resin (meq/dgm).

U.S. Pat. No. 4,617,321 disclosed another example process whereby 500 ml of N-methylolmethacrylamide and 340 grams of methacrylamide were sequentially added to a solution of 880 ml of 2-sulfoethyl methacrylate dissolved in 1000 ml of water. When this solution homogenized, 29 grams of 2,2′-azobis(2-amidinopropane)dihydrochloride dissolved in 190 ml of water were added. This process produces another example of the curable liquid 36.

This example curable liquid taught by U.S. Pat. No. 4,617,321 was poured into an 11″×13″×2″ rectangular tray into which a sandwich of glass plates and 20 mil thick modacrylic cloth were contained. The tray was heated for two hours at 80° C. which resulted in the cloth being impregnated with a polymerized resin, referred to as a membrane. The resulting membrane was placed in an aqueous sodium bicarbonate solution and analyzed. The analysis revealed the following properties of the membrane:

Mullen Burst=140 psi;

Thickness=0.060 cm;

Resistivity=11.2 ohm-cm²;

Water Content=44.6%; and

Capacity=2.53 meq/dgm.

Another example of the step of preparing the curable liquid 101 with aqueous solvents is disclosed in U.S. Pat. No. 5,037,858 to MacDonald and U.S. Pat. No. 5,354,903 to MacDonald, both of which are incorporated herein by reference. These are related patents and any reference to the disclosure of one of these patents is also a reference to the disclosure of the other. U.S. Pat. No. 5,354,903 disclosed a process that uses water as a solvent to prepare other examples of the curable liquid 36. These examples of the curable liquid 36 are produced by blending a highly concentrated solution of a bifunctional methylenebisacrylamide monomer (CH₂═CHCONH)₂CH₂ (MBA) solution with ionogenic acrylic monomers and a water soluble, free-radical generating catalyst. These examples of the curable liquid 36 can be polymerized and crosslinked to form anion exchange polymers.

U.S. Pat. No. 5,354,903 disclosed a process for producing the highly concentrated solution of MBA by starting with a slurry of MBA in a water soluble, polar solvent. In an embodiment, suitable water soluble, polar compounds can be employed as non-polymerizable (NP) solvents or diluents include amides, such as dimethylformamide (DMF), N-methyl pyrrolidone (NMP), 2-pyrrolidone, dimethylacetamide (DMAC), formamide, and straight chain alcohols, polyether alcohols, ketones and the like. The volume of water soluble, polar solvent present during polymerization determines the percent porosity and substantially fixes the solvent or water holding capacity or content of the resulting polymer. The water soluble, polar solvent used is typically 20 to 50% by volume of the final liquid formulation but may be more or less if so desired.

A suitable ionogenic acrylic monomer may be selected from the following compounds:

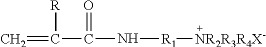

Where: R=H, CH₃;

R₁=C₁-C₂₂;

R₂, R₃, R₄=H, CH₃, alkyl containing C₂-C₂₂, benzyl, phenyl; and

X⁻=Cl⁻,Br⁻,½SO4⁻,NO3⁻. (1)

In an embodiment, the ionogenic acrylic monomer is methacrylamidopropyltrimethylammonium chloride (MAPTAC).

The ionogenic acrylic monomer may also be selected from the following:

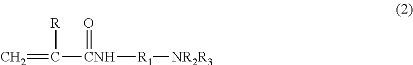

In this latter case the resulting polymer is further reacted with an alkylating agent (such as methyl chloride CH₃Cl) to form an anion-selective polymer. In an embodiment, the monomer in this latter case is dimethylaminopropylmethacrylamide (DMAPMA).

The ionogenic acrylic monomers may comprise between about 25 to 75 mole percent based on the total amount of reactant monomers.

The water soluble, free-radical generating catalysts used for preparing the U.S. Pat. No. 5,354,903 examples of the curable liquid 36, and the relative amounts used, can be the same as those used to prepare the example of the curable liquid 36 disclosed in U.S. Pat. No. 4,617,321.

U.S. Pat. No. 5,354,903 disclosed an example process whereby 20 pounds of MBA were added to 5.8 L of NMP while stirring and heating to 80° C. Next, 0.4 L of 10 N sodium hydroxide solutions was added and heating and stirring continued until a homogeneous solution was obtained. Next, 26 L of a 50% MAPTAC solution was added to the hot homogeneous solution. The resulting solution was then cooled to 30° C. and 500 g of 2,2′-azobis(isovaleronitrile) (available under the trademark Vazo 67) were added and stirring continued until the solution homogenized. This process produces another example of the curable liquid 36.

This example curable liquid taught by U.S. Pat. No. 5,354,903 was poured into an 11″×13″×2″ rectangular tray into which a sandwich of glass plates and 20 mil thick modacrylic cloth were contained. The tray was heated for two hours at 80° C. which resulted in the cloth being impregnated with a polymerized resin, referred to as a membrane. The resulting membrane was placed in an aqueous sodium bicarbonate solution and analyzed. The analysis revealed the following properties of the membrane:

Mullen Burst=140 psi;

Thickness=0.054 cm;

Resistivity=9.0 ohm-cm²;

Water Content=45.6%; and

Capacity=2.4 meq/dgm.

U.S. Pat. No. 5,354,903 disclosed another example process whereby 20 pounds of MBA were added to 5.8 L of NMP while stirring and heating to 80° C. Next, 0.4 L of 10N sodium hydroxide solution was added and heating and stirring continued until a homogeneous solution was obtained. The homogeneous solution was then cooled to 30° C. and 10 L of dimethylaminopropyl methacrylamide (DMAPMA), 13 L of water and 500 g of 2,2′-azobis(isovaleronitrile) were added and stirring continued until the solution was homogeneous. This process produces another example of the curable liquid 36.

This example curable liquid taught by U.S. Pat. No. 5,354,903 was poured into an 11″×13″×2″ rectangular tray into which a sandwich of glass plates and 20 mil thick modacrylic cloth were contained. The tray was treated as described above for the other example curable liquid of U.S. Pat. No. 5,354,903. The resulting membrane was subject to post-curing, alkylation by soaking in a solution of methyl chloride and NMP and then soaking in an aqueous sodium chloride solution. The analysis of this membrane revealed the following properties:

Mullen Burst=150 psi;

Thickness=0.054 cm;

Resistivity=9.7 ohm-cm²;

Water Content=46.8%; and

Capacity=2.2 meq/dgm.

Another example of the step of preparing the curable liquid 101 with aqueous solvents is disclosed in U.S. Pat. No. 4,374,720 to MacDonald, which is incorporated herein by reference. U.S. Pat. No. 4,374,720 disclosed a process that uses water as a solvent to prepare other examples of the curable liquid 36. These other examples of the curable liquid 36 are produced by mixing glycidyl esters, ionogenic methacrylate esters with vinyl and tertiary amine groups and a water soluble acid to form a homogeneous solution of a water soluble, ionic, cross-linking monomer (WSXL). A mixture of the WSXL and a water soluble, free-radical generating catalyst is another example of the curable liquid 36.

The solution of WSXL may also be mixed with another functional monomer, for example an ionogenic methacrylate ester monomer, and the water soluble, free-radical generating catalyst to produce another example of the curable liquid 36.

To produce the WSXL, glycidyl esters of acrylic, methacrylic or crotonic acids are suitable; however, glycidyl methacrylate (GMA) is preferred in an embodiment. The ionogenic methacrylate ester can be various ethenoid monomers containing acrylic or methacrylic groups, including dimethylaminopropyl acrylamide, diethylaminoethyl methacrylate or dimethylaminoethyl acrylate, however, dimethylaminoethyl methacrylate (DMAEMA) is preferred in an embodiment. In an embodiment, the halide acids are water soluble acid, and more particularly hydrochloric acid (HCl). The WSXL may be synthesized using a wide ratio range of GMA to DMAEMA, but, for the purpose of using the resulting cross-linking monomer for the later manufacture of anion-exchange polymers, the GMA comprise about 35% to 45% by weight of the resulting cross-linking monomer according to an embodiment.

U.S. Pat. No. 4,374,720 disclosed an example process whereby 183 grams of concentrated HCl were dissolved into 1346 grams of water to prepare an HCl solution. The acid solution was cooled to room temperature. Next, 765 grams of DMAEMA and 710 grams of GMA were added to the HCl solution. DMAEMA has the structural formula:

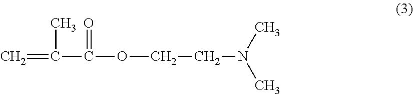

GMA has the formula:

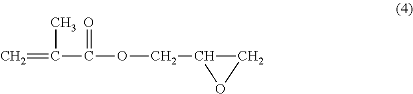

After stirring for about 2 hours, at a temperature of between 40 and 50° C., the mixture was allowed to stand at room temperature. The resulting homogeneous, clear, colorless, solution contained water soluble, ionic, cross-linking bifunctional monomer (WSXL) with the formula:

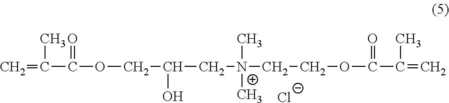

Next, 33 grams of the catalyst 2,2′-azobis(2-amidinopropane)dihydrochloride were added to the homogenous solution of WSXL monomer which produces another example of the curable liquid 36.

This example curable liquid taught by U.S. Pat. No. 4,374,720 was poured into an 11″×13″×2″ rectangular tray into which a sandwich of glass plates and 20 mil thick modacrylic cloth were contained. The tray was heated for two hours at 80° C. which resulted in the cloth being impregnated with a polymerized resin, referred to as a membrane. The resulting membrane was placed in an aqueous sodium bicarbonate solution and analyzed. The analysis revealed the following properties of the membrane:

Mullen Burst=140 psi;

Thickness=0.054 cm;

Resistivity=11.3 ohm-cm²;

Water Content=49.3%; and

Capacity=2.33 milliequivalents Cl⁻ per gram of dry resin.

U.S. Pat. No. 4,374,720 disclosed another example process whereby 765 grams of DMAEMA were added to the homogenous solution of WSXL monomer and the catalyst (as described above) which produces another example of the curable liquid 36 that has a mixture of tertiary amine and quaternary ammonium chloride groups.

This example curable liquid taught by U.S. Pat. No. 4,374,720 was poured into an 11″×13″×2″ rectangular tray into which a sandwich of glass plates and 20 mil thick modacrylic cloth were contained. The tray was heated for two hours at 80° C. which resulted in the cloth being impregnated with a polymerized resin, referred to as a membrane. The resulting membrane was placed in an aqueous sodium bicarbonate solution and analyzed. The analysis revealed the following properties of the membrane:

Mullen Burst=137 psi;

Thickness=0.052 cm;

Resistivity=15.5 ohm-cm²;

Water Content=49.7%; and

Capacity=1.8 milliequivalents Cl⁻ per gram of dry resin.

U.S. Pat. No. 4,374,720 disclosed another example process whereby 1390 grams of a cationic methacrylate monomer was added to the homogenous solution of WSXL monomer and the catalyst (as described above). The cationic methacrylate monomer is a 73 to 77% aqueous solution of the quaternization product of DMAEMA and methyl chloride. The cation methacrylate monomer has the formula:

CH₂═C(CH₃)COO(CH₂)₂N⊕(CH₃)₃Clθ (6)

This cationic methacrylate monomer is commercially available from Alcolac, Inc., Baltimore, Md. under the trademark Sipomer® Q-6-75. The use of the quaternary ammonium salt of DMAEMA and methyl chloride allows a one-step manufacture of one of the example curable liquids 36 taught by U.S. Pat. No. 4,374,720 with substantially all quaternary ammonium groups. Next, 33 grams of the catalyst 2,2′-azobis(2-amidinopropane)dihydrochloride were added which produces another example of the curable liquid 36.

This example curable liquid taught by U.S. Pat. No. 4,374,720 was poured into an 11″×13″×2″ rectangular tray into which a sandwich of glass plates and 20 mil thick modacrylic cloth were contained. The tray was heated for two hours at 80° C. which resulted in the cloth being impregnated with a polymerized resin, referred to as a membrane. The resulting membrane was placed in an aqueous sodium bicarbonate solution and analyzed. The analysis revealed the following properties of the membrane:

Mullen Burst=135 psi;

Thickness=0.063 cm;

Resistivity=10.0 ohm-cm²;

Water Content=51.7%;

Capacity=2.64 milliequivalents Cl⁻ per gram of dry resin.

U.S. Pat. No. 4,374,720 disclosed another example process whereby 930 grams of the monomer DMAEMA and 840 grams of the polyfunctional monomer GMA were added to a solution of 354 grams of glacial acetic acid in 2120 grams of water. After stirring for about two hours, at a temperature between 40 and 50° C., a homogeneous, clear, colorless solution of a water soluble, ionic, cross-linking bifunctional monomer formed having the following formula:

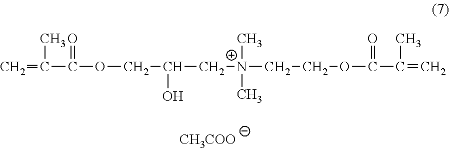

Next, 42 grams of the 2,2′-azobis(2-amidinopropane)dihydrochloride catalyst were added which produces another example of the curable liquid 36.

This example curable liquid taught by U.S. Pat. No. 4,374,720 was poured into an 11″×13″×2″ rectangular tray into which a sandwich of glass plates and 20 mil thick modacrylic cloth were contained. The tray was heated for two hours at 80° C. which resulted in the cloth being impregnated with a polymerized resin, referred to as a membrane. The resulting membrane was placed in an aqueous sodium bicarbonate solution and analyzed. The analysis revealed the following properties of the membrane:

Mullen Burst=130 psi;

Thickness=0.056 cm;

Resistivity=8.6 ohm-cm²;

Water Content=52.1%; and

Capacity=2.31 milliequivalents Cl⁻ per gram of dry resin.

Another example of preparing the curable liquid 101 with aqueous solvents is disclosed in U.S. Pat. No. 7,968,663 and U.S. Pat. No. 8,138,291 to MacDonald and Peters, both of which are incorporated herein by reference. These are related patents, as such; any reference to the disclosure of one of these patents is also a reference to the disclosure of the other. U.S. Pat. No. 7,968,663 disclosed processes that use water as a solvent to produce other examples of the curable liquid 36 by mixing a tertiary amine, an acid, a polyexpoxide and, optionally, a water soluble, free-radical generating catalyst.

The tertiary amine may be an ethylenic tertiary amine. In one example, the ethylenic tertiary amine is selected from the group consisting of dimethylaminopropylmethacrylamide (DMAPMA), dimethylaminopropylacrylamide (DMAPAA), diethylaminopropylmethacrylamide (DEAPMA), dimethylaminoethylmethacrylate (DMAEMA) or mixtures thereof. In another example, the ethylenic tertiary amine monomer is DMAPMA.

The polyepoxide may be any type of polyepoxide having at least two epoxide groups. In one embodiment, the polyepoxide is a diglycidyl ether or a triglycidyl ether. Diglycidyl ethers include, but are not limited to, diethylene glycol diglycidyl ether, diglycidyl 1,2-cyclohexanedicarboxylate, N,N-diglycidyl-4-glycidyloxyaniline, bisphenol A diglycidyl ether, brominated bisphenol A diglycidyl ether, bisphenol F diglycidyl ether, 1,4-butanediol diglycidyl ether, 1,4-butanediyl diglycidyl ether, 1,4-cyclohexanedimethanol diglycidyl ether, glycerol diglycidyl ether, resorcinol diglycidyl ether, bis[4-(glycidyloxy)phenyl]methane, bisphenol A propoxylate diglycidyl ether, dimer acid diglycidyl ester, ethylene glycol diglycidyl ether, brominated neopentyl glycol diglycidyl ether, diglycidyl ether-terminated poly(dimethylsiloxane), poly(ethylene glycol)diglycidyl ether, poly(propyleneglycol)diglycidyl ether, 1,2,3-propanetriol glycidyl ether and 1,3-butanediol diglycidyl ether. Triglycidyl ethers include, but are not limited to, tris(2,3-epoxypropyl) isocyanurate, trimethylolpropane triglycidyl ether, tris(4-hydroxyphenyl) methane triglycidyl ether 2,6-tolylene diisocyanate, tris(4-hydroxyphenyl) methane triglycidyl ether, glycerol propoxylate triglycidyl ether or trimethylolethane triglycidyl ether.

Alternatively, the polyepoxide is a diepoxide. Diepoxides include, but are not limited to, 1,3-butadiene-diepoxide, 1,3-butadiene diepoxide, dicyclopentadiene dioxide, or methyl cis, cis-11,12,14,15-diepoxyeicosanoate.

The epoxide quaternizes the tertiary amine to form a quaternary ammonium monomer. The quaternary ammonium monomer is also crosslinked by the epoxide to make the monomer water insoluble. Without crosslinking, the resulting polymers would dissolve in water and would be ineffective for use in ion exchange materials. The polymer that results from the curable liquid 36D may be highly crosslinked, crosslinked in the range of from about 50 to about 100 percent or the polymer may be fully crosslinked.

The quaternizing reaction is conducted in the presence of an acid. The acid prevents the polyepoxide from self-polymerizing by quenching the reaction. The amount of quenching is controlled by the amount of acid used in the reaction. The acid may be any type of acid. For example, the acid may be a mineral acid such as hydrochloric acid, methane sulfonic acid, sulfuric acid or phosphoric acid. The acid is added in any amount suitable for quenching the polyepoxide. For example, the acid may be present in an amount of from about 75 percent by mole weight to about 125 percent by mole weight, based on the mole weight of the tertiary amine. In another example, the acid may be present in an amount of from about 75 percent by mole weight to about 100 percent by mole weight, based on the mole weight of the tertiary amine.

The example curable liquids 36 disclosed by U.S. Pat. No. 7,968,663 can be synthesized using a wide ratio range of the tertiary amine relative to the polyepoxide. For example, the ratio may be from about 0.3 to about 1.5 moles of the tertiary amine to each equivalent mole of the polyepoxide. In another example, the ratio is from about 0.5 to about 1.0 moles of the tertiary amine monomer per equivalent mole of the polyepoxide.

In another example of the curable liquid 36, further ethylenic monomers may be added to increase or decrease the ion exchange capacity of the membrane 50 that is made from the example curable liquid 36 taught by U.S. Pat. No. 7,968,663. Examples of ethylenic monomers that lower the ion exchange capacity include, but are not limited to, methacrylamine, N-methylmethacrylamide, N-vinyl pyrrolidinone or N-vinyl caprolactam. Examples of ethylenic monomers that raise the ion exchange capacity include, but are not limited to, methacrylamidopropyl trimethylammonium chloride (MAPTAC) or trimethylammoniumethyl methacrylate chloride (TMAEMC).

The ethylenic monomers may be added to the reaction mixture with the other reactants. The ethylenic monomers may be added in any amount suitable for affecting the ion exchange capacity of the ion exchange polymer. For example, the ethylenic monomer is added in an amount of from about 0 to about 50 molar percent of the tertiary amine. In another example, the ethylenic monomer may be added in an amount of from about 10 to about 40 molar percent of the tertiary amine. In yet another example, the ethylenic monomer may be added in an amount of from about 20 to about 40 molar percent of the tertiary amine.

Polymerization of the example curable liquids 36 taught by U.S. Pat. No. 7,968,663 may occur simultaneously with the quaternizing and crosslinking of the tertiary amine. The reaction of the tertiary amine and polyepoxide and the polymerization reaction may be carried out by heating the reactants and monomers to a suitable temperature and for a time sufficient for quaternizing and crosslinking the tertiary amine and for polymerizing the quaternary ammonium monomer.

Optionally, the water soluble, free-radical generating catalysts disclosed in U.S. Pat. No. 4,617,321 may be included in any amount suitable for aiding the polymerization of the example curable liquid taught by U.S. Pat. No. 7,968,663. For example, the catalyst may be used in an amount of from about 0.1 to about 5.0 percent by weight of the reaction mixture.

U.S. Pat. No. 7,968,663 disclosed an example process whereby 30.6 g of DMAPMA (0.18 mole), 15.4 g of hydrochloric acid (0.16 mole), 23.6 g of 1,2,3-propanetriol glycidyl ether (GE100) (0.09 mole) and 28.0 g of water were mixed and stirred for one hour. After which, 1.4 g of the catalyst, 2,2′-azobis(N,N′-dimethylene isobutyramidine)dihydrochloride were added to produce another example of the curable liquid 36D.

This example curable liquid taught by U.S. Pat. No. 7,968,663 was spread onto acrylic cloth between two Mylar sheets and sandwiched between glass plates. This cloth, Mylar and glass plate sandwich was heated for 30 minutes hours at 85° C. which resulted in a cured membrane. The resulting membrane was placed in a water and analyzed. The analysis revealed the following properties of the membrane:

Thickness=0.063 cm

Resistivity=11.1 ohm-cm²

Water Content=43.8%

Capacity=2.67 milliequivalents per gram of dry resin in the nitrate form.

U.S. Pat. No. 7,968,663 disclosed another example process whereby 30.6 g of DMAPMA (0.18 mole), 15.4 g hydrochloric acid (0.16 mole), 23.6 g of 1,2,3-propanetriol glycidyl ether (GE100) (0.09 mole), 9.4 g of N-Vinyl caprolactam (0.068 mole) and 28.0 g of water were mixed and stirred for one hour. After which, 1.4 g of the V-2,2′-azobis(N,N′-dimethylene isobutyramidine)dihydrochloride catalyst were added to produce another example of the curable liquid 36.

This example curable liquid taught by U.S. Pat. No. 7,968,663 was spread onto acrylic cloth between two Mylar sheets and sandwiched between glass plates. This cloth, Mylar and glass plate sandwich was heated for 30 minutes hours at 85° C. which resulted in a cured membrane. The resulting membrane was placed in water and analyzed. The analysis revealed the following properties of the membrane:

Thickness=0.067 cm

Resistivity=15.4 ohm-cm²

Water Content=42.9%

Capacity=2.35 milliequivalents per gram of dry resin in the nitrate form.

The amounts of the chemical components to make larger batches of the example curable liquids 36 taught by U.S. Pat. No. 7,968,663 are shown below in Table 1. These larger batches are suitable for use with the apparatus 10.

TABLE 1
Formulations for various batch sizes for producing the example curable liquid taught
by U.S. Pat. No. 7,968,663.

| Batch | | | | | | |
|---|---|---|---|---|---|---|
| Size | DMAPMA | | CHDMDGE | | | |
| (Kg) | (Kg) | HCl 36% (Kg) | (Kg) | V-CAP (Kg) | VA-O44 (g) | H₂O (Kg) |
| 1.0 | 0.258 ± 0.020 | 0.145 ± 0.020 | 0.185 ± 0.020 | 0.056 ± 0.020 | 8.50 ± 0.05 | 0.358 ± 0.020 |
| 5.0 | 1.288 ± 0.050 | 0.723 ± 0.050 | 0.923 ± 0.050 | 0.279 ± 0.050 | 42.50 ± 0.25 | 1.788 ± 0.050 |
| 10.0 | 2.575 ± 0.150 | 1.445 ± 0.150 | 1.846 ± 0.150 | 0.558 ± 0.150 | 85.00 ± 0.50 | 3.575 ± 0.150 |
| 20.0 | 5.150 ± 0.250 | 2.890 ± 0.250 | 3.693 ± 0.250 | 1.117 ± 0.250 | 170.00 ± 1.00 | 7.150 ± 0.250 |
| 30.0 | 7.725 ± 0.300 | 4.335 ± 0.300 | 5.539 ± 0.300 | 1.675 ± 0.300 | 255.00 ± 1.50 | 10.725 ± 0.300 |

In Table 1, DMAPMA is Dimethylaminopropyl methacrylamide; HCl is Hydrochloric Acid (36%); CHDMDGE is Cyclohexanedimethanol Diglycidyl ether; V-CAP is N-Vinyl Caprolactam; and VA-044 is the catalyst 2,2′-Azobis[2-(2-imidazolin-2-yl)propane]dihydrochloride.

The membranes 50 produced using the apparatus 10 and the example curable liquid taught by U.S. Pat. No. 7,968,663 were characterized by testing the following parameters: the ion exchange capacity (meq/dg), water content (%), wet thickness (mm) and area-resistance (Ohm-cm²). The results of this characterization are provided below in Table 2.

TABLE 2
Characterization of membranes made with the
apparatus 10 using the example curable liquid
36 taught by U.S. Patent U.S. 7,968,663.

| | | Lower | Upper | |
|---|---|---|---|---|
| | | Spec | Spec | |
| Parameter | Units | Limit | Limit | Mean |
| Ion Exchange Capacity | meq/dg | 1.75 | 2 | 1.9 |
| Water Content | % | 42 | 50 | 46.4 |
| Wet Thickness | mm | 0.57 | 0.62 | 0.61 |
| Area-Resistance | Ohm- | 14 | 20 | 16.7 |
| | cm2 | | | |

Another example of preparing the curable liquid 101 with aqueous solvents is disclosed in U.S. patent application Ser. No. 13/253,227 to MacDonald et al., filed on Oct. 5, 2011, which is incorporated herein by reference. U.S. patent application Ser. No. 13/253,227 disclosed a process that uses water as a solvent to prepare other examples of the curable liquid 36. These other examples of the curable liquid 36 are produced by mixing a primary crosslinker and a secondary crosslinker. Optionally, the primary and secondary crosslinkers may be monomers. In one example, the primary crosslinker includes a crosslinked ionic monomer including at least one cationic quaternary ammonium group. In another example, the primary crosslinker includes a crosslinked ionic monomer that includes at least one vinyl group, such as an acrylic group. In another example, the primary crosslinker includes a crosslinked ionic monomer that includes at least two ionic functional groups and at least two vinyl groups.

The crosslinked ionic monomer may be prepared by reacting a polyepoxide with a tertiary amine including an acrylic group in the presence of an acid.

The tertiary amine may be an ethylenic tertiary amine. Examples of an ethylenic tertiary amine with acrylic groups include dimethylaminopropylmethacrylamide (DMAPMA), dimethylaminopropylacrylamide (DMAPAA), diethylaminopropylmethacrylamide (DEAPMA), and dimethylaminoethylmethacrylate (DMAEMA).

The polyepoxide may be any type of polyepoxide including at least two epoxide groups. In one embodiment, the polyepoxide is a diglycidyl ether or a triglycidyl ether. Diglycidyl ethers include, but are not limited to, diethylene glycol diglycidyl ether, diglycidyl 1,2-cyclohexanedicarboxylate, N,N-diglycidyl-4-glycidyloxyaniline, bisphenol A diglycidyl ether, brominated bisphenol A diglycidyl ether, bisphenol F diglycidyl ether, 1,4-butanediol diglycidyl ether, 1,4-butanediyl diglycidyl ether, 1,4-cyclohexanedimethanol diglycidyl ether, glycerol diglycidyl ether, resorcinol diglycidyl ether, bis[4-(glycidyloxy)phenyl]methane, bisphenol A propoxylate diglycidyl ether, dimer acid diglycidyl ester, ethylene glycol diglycidyl ether, brominated neopentyl glycol diglycidyl ether, diglycidyl ether-terminated poly(dimethylsiloxane), poly(ethylene glycol)diglycidyl ether, poly(propyleneglycol)diglycidyl ether, 1,2,3-propanetriol glycidyl ether and 1,3-butanediol diglycidyl ether. Triglycidyl ethers include, but are not limited to, tris(2,3-epoxypropyl)isocyanurate, trimethylolpropane triglycidyl ether, tris(4-hydroxyphenyl)methane triglycidyl ether 2,6-tolylene diisocyanate, tris(4-hydroxyphenyl)methane triglycidyl ether, glycerol propoxylate triglycidyl ether and trimethylolethane triglycidyl ether.

In another embodiment, the polyepoxide is a diepoxide. Diepoxides include, but are not limited to, 1,3-butadiene-diepoxide, 1,3-butadiene diepoxide, dicyclopentadiene dioxide and methyl cis,cis-11,12;14,15-diepoxyeicosanoate.

The acid may be any type of acid, such as a mineral acid. In one example, the acid includes, but is not limited to, hydrochloric acid, methane sulfonic acid, sulfuric acid or phosphoric acid. In one example, the acid is present in an amount of from about 75 percent by mole weight to about 125 percent by mole weight, based on the mole weight of the tertiary amine. In another example, the acid is present in an amount of from about 75 percent by mole weight to about 100 percent by mole weight, based on the mole weight of the tertiary amine.

The tertiary amine is quaternized and crosslinked in the reaction that forms the primary crosslinker. In one example, the temperature ranges from about 40° C. to about 150° C. In another example, the temperature range is from about 60° C. to about 110° C. and in another example the temperature range is from about 75° C. to about 100° C. In one example, the reaction time is from about 1 minute to about 2 hours. In another example, the reaction time is from about 10 minutes to about 1 hour. In another example, the reaction time is from about 20 minutes to about 45 minutes.

The primary crosslinker may be synthesized using a wide ratio range of the tertiary amine to the polyepoxide. In one example, the ratio is from about 1.0 to about 2.5 moles of the tertiary amine to each equivalent mole of the polyepoxide. In another example, the ratio is from about 1.5 to about 2.0 moles of the tertiary amine monomer per equivalent mole of the polyepoxide. In another example, the ratio is about 1.5 moles of the tertiary amine monomer per equivalent mole of the epoxide.

One example of the crosslinked ionic monomer has the following formula:

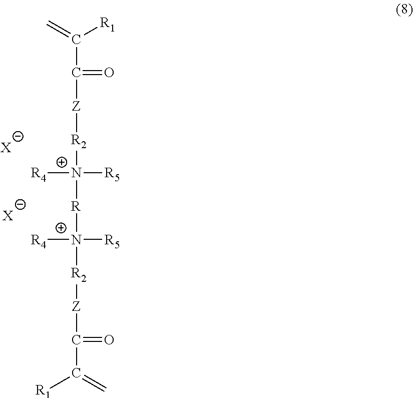

wherein:

R is —[CH₂—CH(OH)]₂—W;

R₁ is hydrogen or a C₁-C₁₂ alkyl group;

Z is oxygen or N—R₃; R₂ is —[CH₂]ₙ—;

R₃ is hydrogen or —[CH₂]ₘ—CH₃;

R₄ and R₅ are each, independently, —[CH₂]ₘ—CH₃;

X is selected from the group consisting of Cl, Br, I and acetate;

W is a bridging group or atom;

m is an integer from 0 to 20; and

n is an integer from 1 to 20.

In one example, R₁ is a C₁-C₆ alkyl group. In another example, R₁ is methyl, ethyl, propyl, butyl or isobutyl.

In one example, Z is ammonia, trimethylammonia or triethylammonia.

W is a bridging group or atom. In one example, W is a hydrocarbon group, an inorganic group or inorganic atom. In another example, W is a C₁-C₃₀ alkyl group, C₁-C₃₀ alkyl ether group, C₆-C₃₀ aromatic group, C₆-C₃₀ aromatic ether group or a siloxane. In another embodiment, W is a C₁-C₆ alkyl group, C₁-C₆ alkyl ether group, a C₆-C₁₀ aromatic group or a C₆-C₁₀ aromatic ether group. In another embodiment, W is methyl, ethyl, propyl, butyl, isobutyl, phenyl, 1,2-cyclohexanedicarboxylate, bisphenol A, diethylene glycol, resorcinol, cyclohexanedimethanol, poly(dimethylsiloxane), 2,6-tolylene diisocyanate, 1,3-butadiene or dicyclopentadiene.

In another example, m is an integer from 0 to 10. In another example, m is an integer from 0 to 5. In another example, n is an integer from 1 to 10. In another example, n is an integer from 1 to 5.

The secondary crosslinker may be a non-ionic monomer. In another example, the secondary crosslinker includes divinyllic functionality. In another example, the secondary crosslinker may be N-methacrylamidomethyacrylamide.

The secondary crosslinker may be prepared by reacting an acrylamide compound with another acrylamide compound including hydroxyl groups. In one example of the secondary crosslinker, the acrylamide may be methacrylamide (MAA). In another example, the acrylamide including hydroxyl groups may be N-hydroxymethylacrylamide (NHMA). In one example, the reaction occurs in the presence of an acid. In another example, the reaction may proceed at room temperature.

The secondary crosslinker may be synthesized using a wide ratio range of the acrylamide and acrylamide including hydroxyl groups. In one example of the secondary crosslinker, the ratio is from about 0.1 to about 1.5 moles of the acrylamide to the acrylamide including hydroxyl groups. In another example, the ratio is from about 0.1 to about 0.5 moles of the acrylamide to the acrylamide including hydroxyl groups. In another example, the ratio is from about 1.0 moles to about 1.5 moles of the acrylamide to the acrylamide including hydroxyl groups.

The acid may be any type of acid, such as a mineral acid. In one example, the acid includes, but is not limited to, hydrochloric acid, methane sulfonic acid, sulfuric acid or phosphoric acid. In one example, the amount of acid may be in a ratio of from about 0.1 mole to about 1.5 moles of the acid to the acrylamide including the hydroxyl groups. In another example, the amount of acid may be in a ratio of from about 0.1 mole to about 1.0 mole of the acid to the acrylamide including the hydroxyl groups. In another example, the amount of acid may be in a ratio of from about 0.1 mole to about 0.5 mole of the acid to the acrylamide including the hydroxyl groups.

Optionally, the example curable liquid 36 that is disclosed by U.S. patent application Ser. No. 13/253,227 may include the addition of a photoinitiator. Non-limiting examples of photoinitiators include benzophenone, benzyl, antraquinone, eosin or methylene blue.

Optionally, the example curable liquid 36 that is disclosed by U.S. patent application Ser. No. 13/253,227 may include an acid. In one example, the acid is a mineral acid. In another embodiment, the acid includes, but is not limited to, hydrochloric acid, methane sulfonic acid, sulfuric acid or phosphoric acid. The acid may be added in an amount of from about 1 percent by weight to about 5 percent by weight, based on the weight of the reaction mixture.

Optionally, a catalyst may be added to the curable liquid 36 that is disclosed by U.S. patent application Ser. No. 13/253,227 to aid in polymerization. The catalyst may be spontaneously activated or activated by heat, electromagnetic radiation, electron beam radiation or by chemical promoters. The catalyst may be added in any amount suitable for aiding in polymerization. In one embodiment, the catalyst is in an amount of from about 0.1 to about 5.0 percent by weight of the reaction mixture. In another embodiment, the catalyst may be added in an amount of from about 0.5 percent by weight to about 3.0 percent by weight, based on the weight of the reaction mixture. In another embodiment, the catalyst may be added in an amount of from about 0.5 percent by weight to about 1.0 percent by weight, based on the weight of the reaction mixture.

In one example, the catalyst is a radical polymerization initiator or a photopolymerization initiator. In one embodiment, the catalyst is a peroxide. The peroxide includes, but is not limited to, methyl ethyl ketone peroxide and other suitable water soluble peroxide initiators. In another embodiment, the catalyst is a water soluble or oil soluble azo initiator. More particularly, the catalyst is water soluble. The azo initiator includes, but is not limited to, 2,2′-azobis[2-(2-imidazolin-2-yl)propane]dihydrochloride, 2,2′-azobis(N,N′-dimethylene isobutyramidine)dihydrochloride, 2,2′-azobis(2-methylpropionamidine)dihydrochloride, 2,2′-azobis[N-(2-carboxyethyl)-2-methylpropionamidine]hydrate, 2,2′-azobis{2-[1-(2-hydroxyethyl)-2-imidazolin-2-yl)propane], 2,2′-azobis[2-methyl-N-(2-hydroxyethyl)propionamide] and dimethyl 2,2′-azobis(2-methylpropionate).

The term “chemical promoters” is used herein to refer to a substance, which increases the rate of polymerization either by itself or in combination with another catalyst. UV radiation polymerization agents can become more efficient in the presence of chemical promoters, which are photoinitiators or chemical compounds that generate free radicals. For example, methyl ethyl ketone peroxide can function as a catalyst itself, but its rate of initiation can be greatly increase by small amounts of transition metal salt chemical promoters, such as, for example, cobalt naphthenate. Non-limiting examples of photoinitiating chemical promoters include eosin and methylene blue and other suitable water soluble UV initiators.

U.S. patent application Ser. No. 13/253,227 (filed Oct. 5, 2011) disclosed an example process that produces an example of the curable liquid 36. This process produces the example curable liquid 36 from the mixture of two solutions. Solution 1 was a primary crosslinker and solution 2 was a secondary crosslinker.

### Solution 1:

27.67 g DMAPMA was measured into a 250-ml beaker. 21.34 g of deionized water was added to the beaker and the solution was stirred for 10 min using a magnetic stirrer. 15.53 g hydrochloric acid was added to the solution at a rate so that the temperature did not rise above 60° C. After the addition of the acid, 27.77 g of a cyclohexanedimethanol diglycidyl ether was added to the solution. The solution was heated to 78° C. and stirred for 30 minutes. After 30 minutes, the solution was cooled to room temperature.

### Solution 2:

4.50 g NHMA was measured into a 100 ml beaker and 2.16 g HCl was added slowly at a rate so that the temperature did not rise above 40° C. 1.82 g MAA was then added to the solution and the reaction mixture was stirred using a magnetic stirrer at room temperature for 15 min. After 15 min, 0.8 g of 2,2′-azobis[2-(2-imidazolin-2-yl)propane]dihydrochloride supplied by Wako Chemicals USA, Dallas, Tex. (VA-044) was added and the solution stirred for another 15 minutes or until all of the catalyst dissolved.

The example curable liquid 36 taught by U.S. patent application Ser. No. 13/253,227 was prepared by adding solution 2 to solution 1 and stirring the reaction mixture for about 10 min. The total mix quantity of the combined solutions was 100 g. The final mix was prepared by adding solution 2 to solution 1 and stirring the reaction mixture for about 10 min. The total mix quantity of the combined solutions was 100 g.

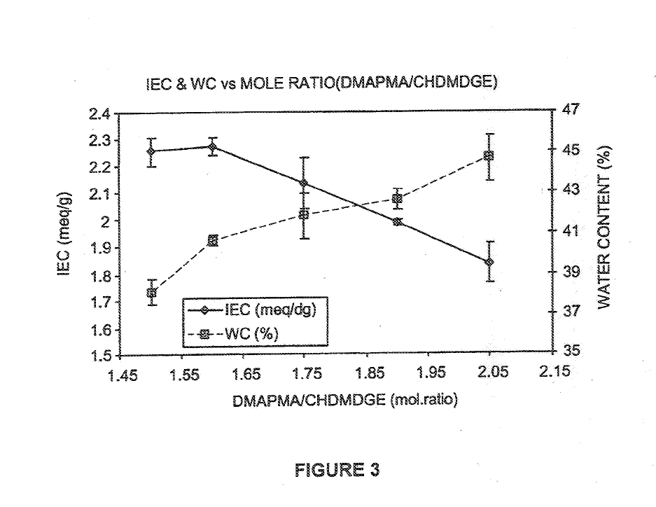

A 6″×6″ mylar sheet was place onto a 6″×6″ glass plate and the final mix solution was spread onto the mylar sheet. An acrylic cloth was placed on the mylar sheet and the mix was allowed to spread across the cloth. Another 6″×6″ mylar sheet was placed on the cloth and excess solution mix was wiped off the cloth. Another 6″×6″ glass plate was placed on the second mylar sheet and the glass/mylar/cloth/mylar/glass sandwich structure was clamped using binder clips. The sandwich was placed in the oven at 85° C. for 60 min for curing. After curing, the membrane envelope was removed from the oven, cooled for 15 min and the glass plates were pried open. The mylar sheets were then carefully separated from the membrane. The membrane was placed in deionized water for at least 4 hours and analyzed. IEC and water content were measured. Results are shown in FIG. 3.

Additional membranes were prepared in accordance with the example curable liquid taught by U.S. patent application Ser. No. 13/253,227 except that the mole ratio of DMAPMA to cyclohexanedimethanol diglycidyl ether was varied. The results and mole ratios are shown FIG. 3. The thicknesses of the membranes were in the range of 0.55 mm to 0.70 mm. The resistivity varied from 15 to 22 Ohm-cm². The smoothness factor was 4 to 4.5.

For these example membranes made from the example curable liquids taught by U.S. patent application Ser. No. 13/253,227, the ion exchange capacity (IEC) was expressed as milligram-equivalents per gram of dry ion exchange resin in the nitrate form (i.e., not including fabric). The water content (WC) was expressed as percent by weight of the wet ion exchange resin in the nitrate form (i.e., not including fabric). The smoothness factor was determined by visually comparing the membrane to a commercial membrane having a smoothness factor of 5.

Table 3 provides the amounts of the chemical components that may be used to make a larger batch of the example curable liquid 36 taught by U.S. patent application Ser. No. 13/253,227. This larger batch is suitable for use with the apparatus 10.

TABLE 3
Formulation for a larger batch of the example curable liquid taught by U.S. patent
application No. 13/253,227.

| | Solution 1 | | | | Solution 2 | | | |
|---|---|---|---|---|---|---|---|---|
| Batch | | HCl | | | NHMA | | HCl | VA- |
| size | DMAPMA | (36%) | CHDMDGE | H₂0 | (48%) | MAA | (36%) | 044 |
| (kg) | (kg) | (kg) | (kg) | (kg) | (kg) | (kg) | (kg) | (g) |
| 30.2 | 8.2998 ± 0.2 | 4.658 ± 0.2 | 8.331 ± 0.2 | 6.401 ± 0.2 | 1.348 ± 0.2 | 0.545 ± 0.05 | 0.650 ± 0.05 | 226.76 |

In Table 3, DMAPMA is Dimethylaminopropyl methacrylamide; HCl is Hydrochloric Acid (36%); CHDMDGE is Cyclohexanedimethanol Diglycidyl ether; H20 is deionized water; NHMA 48% is N-(hydroxymethyl) acrylamide, 48 wt % solution in water; MAA is Methacrylamide; HCl is Hydrochloric Acid (36%); and VA-044 is the catalyst 2,2′-Azobis[2-(2-imidazolin-2-yl)propane]dihydrochloride.

Membranes 50 produced using the apparatus 10 and the example curable liquid taught by U.S. patent application Ser. No. 13/253,227 were characterized by testing the following parameters: the ion exchange capacity (meq/dg), water content (%), wet thickness (mm) and area-resistance (Ohm-cm²). The results of this characterization are provided below in Table 4.

TABLE 4
Characterization of membranes made with the
apparatus 10 using the example curable liquid 36
taught by U.S. Patent Application No. 13/253,227.

| | | Lower | Upper | |
|---|---|---|---|---|
| | | Spec | Spec | |
| Parameter | Units | Limit | Limit | Mean |
| Ion Exchange Capacity | meq/dg | 1.8 | 2.2 | 2 |
| Water Content | % | 37.5 | 41.5 | 40 |
| Wet Thickness | mm | 0.6 | 0.85 | 0.7 |
| Area-Resistance | Ohm- | 18.5 | 23 | 20 |
| | cm2 | | | |

The chemical components of the curable liquid 36 may be combined in the presence of an aqueous solvent. So long as the solvent is not itself polymerizable and the components are soluble in it. Solvents suitable in this embodiment include, but are not limited to, water, polyethylene glycols, dimethylsulfoxide, 2-pyrrolidone, N-methyl pyrrolidone and mixtures thereof. In an embodiment, the solvent is water.

The amount of aqueous solvent is added in any amount suitable for solubilizing the components. In one example, the amount of solvent is from about 10 to about 90 percent by weight based on the total weight of the reaction mixture. In another example, the amount of solvent is from about 20 to about 70 percent by weight based on the total weight of the reaction mixture. In another example, the amount of solvent is from about 25 to about 50 percent by weight based on the total weight of the reaction mixture.

The chemical components of the various example curable liquids 36 described above may be mixed in any manner that is conventional for the amounts that are being used. The various example curable liquids 36 described above include both volumes and masses of specific chemical components that are suitable for producing membranes. However, the described volumes and masses can be changed, while maintaining about the same relative ratios of the chemical components, to provide a batch volume of the curable liquid 36 that is suitable for producing membranes 50 using the apparatus 10 and the method 100. For example, the curable liquid 36 can be made in batches with volumes between 30 and 200 L. As shown in Tables 1 and 3, the curable liquid 36 can also be made in batches of various amounts. As shown in Tables 2 and 4, these batches can be used in the apparatus 10 to make membranes 50 that are suitable for ion exchange processes. Based upon the results of the characterization data provided in Tables 2 and 4 and the characterization of the membranes produced by the various example curable liquids described above, the inventors expect that any of the example curable liquids 36 described herein can be made in larger batch volumes. These larger batch volumes of curable liquids 36 can be used with the apparatus 10 and the process 10 to produce membranes 50 that are suitable for ion exchange processes.

The step of casting a precursor 102 comprises a step of forming a film pocket 108, a step of sealing the pocket 109 and a step of introducing the curable liquid 36 into the film pocket to wet 110 the substrate 24. In an embodiment, the step of casting a precursor 102 is continuous. The pocket is formed 108 by layering the substrate 24 between two layers of film 28. When the pocket is formed 108, the step of sealing the pocket 109 includes melting at least a portion of the lateral edges of the film pocket and pressing the melted portions together to form a seal. The melting step may be achieved by various approaches, including heat, pressure, ultrasonic welding, chemical welding and combinations thereof. When the pocket is formed 108 and sealed 109, the curable liquid 36 is introduced into the film pocket to wet 110 the substrate 24 and form the membrane precursor 32.

The step of curing the precursor to form a cured membrane 104 comprises a step of either heating or irradiating the membrane precursor 32, or both. In an embodiment, the step of curing the precursor to form a cured membrane 104 is continuous. The membrane precursor 32 can be irradiated with infrared, microwave, ultraviolet or other forms of radiation. During the curing step 104, the curable liquid 34 undergoes a polymerizing reaction and the membrane precursor 32 changes into a cured form of the membrane 50.

A suitable temperature range for curing the example curable liquids 36 disclosed by U.S. Pat. No. 4,617,321, U.S. Pat. No. 5,354,903 and U.S. Pat. No. 4,374,720 is between about 40° C. to about 100° C. In an embodiment, the temperature range is from about 60° C. to about 80° C.

A suitable temperature range for curing the example curable liquids 36 disclosed by U.S. Pat. No. 7,968,663 is between about 40° C. and about 150° C. Temperature ranges between about 60° C. to about 110° C. or about 85° C. to about 100° C. are also suitable.

A suitable temperature range for curing the example curable liquids 36 disclosed by U.S. patent application Ser. No. 13/253,227 is between about 40° C. and about 150° C. Temperature ranges between about 60° C. to about 110° C. or about 75° C. to about 100° C. are also suitable.

The processing step 106 comprises the steps of separating the films 28 from the membrane 50 and conditioning 120 the membrane 50. The separated films 28 can be recycled or reused. Conditioning 120 the membrane 50 includes a step of extracting residues 121 from the membrane 50 by soaking or flushing the membrane 50 with extraction fluids. Optionally, the step of extracting residues 121 can also include a step of optimizing the conditions to increase the amount of residues that are extracted. For example, temperature, pH and the chemical composition of the extraction fluids can be optimized based upon the type of residues that are within the membrane 50. The conditioning step 120 can also include a step of washing 122 the extraction fluids from the membrane 50. Optionally, the steps of extracting 121 and washing 122 can be repeated, or prolonged, by conveying the membrane 50 multiple times through one extraction tank 56 and one wash tank 58. As a further option, the membrane 50 can be conveyed through one or more extraction tanks 56 and one or more wash tanks 58.

The processing step 106 further includes a step of testing 124 the membrane 50. The testing step 124 includes a step of applying 126 a dye to a surface of the membrane 50 and providing 128 a contrast material 70 to a surface of the membrane 50 that is opposite to the dyed surface. Dye that flows through any physical flaws in the membrane 50 will mark the contrast material 70. The dye marked contrast material 70 provides a visual cue that the membrane 50 contains physical flaws. Optionally, the testing step 124 can also include a step of removing excess dye from the dyed surface of the membrane 50. The testing step 124 further includes a step of inspecting 130 the contrast material 70 for dye marks. For example, an operator can inspect the contrast material 70 to identify flawed regions of the membrane 50 as regions where there are dye marks on the contrast material 70.

The processing step 106 further includes a step of cutting 132 the membrane 50 to a desired size. Optionally, the step of inspecting 130 can occur after the cutting 132 step (as indicated by the stippled arrows in FIG. 2A).

The membrane 50 is conveyed between process step areas at a desired speed and a desired tension along a path of travel, for example upon the rollers 53, 53a or the platform 60. In an embodiment, the processing steps 106 are adapted to be performed at a common line speed. For example, the line speed can be pre-set based upon the components of the curable liquid 36, or other factors, and stored in the controller 82. Further, various pre-set line speeds may be stored in the controller 82 for various different curable liquids 36 to optimize the time for the steps of extracting residues 121 and washing 122 the membrane 50. The user may input the type of curable liquid 36 into the controller 82. Based upon the input, the controller 82 selects the pre-set line speed and regulates the line speed of the conveyor system 51 to match the pre-set line speed. Optionally, the membrane 50 can be continuously conveyed at the desired line speed from the curing step 104 through all the processing steps 106. In an embodiment, the membrane 50 is continuous with the membrane precursor 32, which is continuous with the substrate 24, and the substrate 24, the membrane precursor 32 and the membrane 50 are continuously conveyed through all steps of the method 100. For example, the membrane 50 may be conveyed at a line speed within a range of 3.5 feet per minute (fpm) to 6 fpm. In another example, the membrane 50 may be conveyed at a line speed within a range of 4.5 fpm to 5 fpm.

This written description uses examples to disclose the invention, including the best mode, and also to enable any person skilled in the art to practice the invention, including making and using any devices or systems and performing any incorporated methods. The patentable scope of the invention is defined by the claims, and may include other examples that occur to those skilled in the art.

What is claimed is:

1. A method for manufacturing a membrane, the method comprising:
a. preparing a curable liquid with an aqueous solvent;
b. casting a membrane precursor; and
c. curing the membrane precursor to form a membrane,
wherein the step (b) comprises introducing the curable liquid into a film pocket and wetting a substrate, and wherein the steps (b) and (c) operate continuously.

2. The method of claim 1, wherein the step (a) comprises mixing a water soluble aliphatic sulfonic acid monomer with a pair of crosslinking monomers and a water soluble free-radical generating catalyst.

3. The method of claim 2, wherein the water soluble, aliphatic sulfonic acid monomer is selected from a group consisting of 2-acrylamido-2-methylpropane sulfonic acid, sulfoethyl methacrylate, and sulfopropyl methacrylate.

4. The method of claim 2, wherein the pair of crosslinking monomers are selected from the group consisting of acrylamide paired with N-methylolacrylamide and methacrylamide paired with N-methylolmethacrylamide.

5. The method of claim 1, wherein the step (a) comprises mixing a solution of a bifunctional methylenebisacrylamide monomer with an ionogenic acrylic monomer and a water soluble, free-radical generating catalyst.

6. The method of claim 5, wherein the ionogenic acrylic monomer is selected from a group consisting of compounds with the following formula: 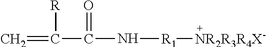
wherein:
R=H, CH₃;
R₁=C₁-C₂₂;
R₂, R₃, R₄=H, CH₃, alkyl containing C₂-C₂₂, benzyl, phenyl; and
X⁻=Cl⁻,Br⁻,½SO4⁻,NO3⁻.

7. The method of claim 5, wherein the ionogenic acrylic monomer has the following formula:

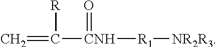

8. The method of claim 1, wherein the step (a) comprises mixing a water soluble, ionic, cross-linking monomer and a water soluble, free-radical generating catalyst.

9. The method of claim 8, wherein the water soluble, ionic, crosslinking monomer is a product of mixing a glycidyl ester, an ionogenic methacrylate ester and a water soluble acid, wherein the ionogenic methacrylate ester comprises a vinyl group and a tertiary amine group and wherein the water soluble, ionic, cross-linking monomer has the following formula:

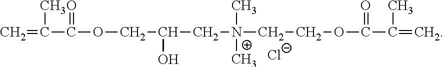

10. The method of claim 8, further comprising adding an ionogenic methacrylate ester monomer to the curable liquid.

11. The method of claim 1, wherein the step (a) comprises mixing a tertiary amine, an acid, and a polyepoxide.

12. The method of claim 11, wherein the tertiary amine is selected from a group consisting of dimethylaminopropylmethacrylamide, dimethylaminopropyl acrylamide, diethylaminopropylmethacrylamide, dimethylaminoethyl methacrylate, and mixtures thereof.

13. The method of claim 11, wherein the polyepoxide is selected from the group consisting of diethylene glycol diglycidyl ether; diglycidyl 1,2-cyclohexanedicarboxylate; N,N-diglycidyl-4-glycidyloxyaniline; bisphenol A diglycidyl ether; brominated bisphenol A diglycidyl ether; bisphenol F diglycidyl ether; 1,4-butanediol diglycidyl ether; 1,4-butanediyl diglycidyl ether; 1,4-cyclohexanedimethanol diglycidyl ether; glycerol diglycidyl ether; resorcinol diglycidyl ether; bis[4-(glycidyloxy)phenyl]methane; bisphenol A propoxylate diglycidyl ether; dimer acid diglycidyl ester; ethylene glycol diglycidyl ether; brominated neopentyl glycol diglycidyl ether; diglycidyl ether-terminated poly(dimethylsiloxane); poly(ethylene glycol)diglycidyl ether; poly(propyleneglycol)diglycidyl ether; 1,2,3-propanetriol glycidyl ether; 1,3-butanediol diglycidyl ether; tris(2,3-epoxypropyl)isocyanurate; trimethylolpropane triglycidyl ether; tris(4-hydroxyphenyl)methane triglycidyl ether 2,6-tolylene diisocyanate; tris(4-hydroxyphenyl)methane triglycidyl ether; glycerol propoxylate triglycidyl ether; trimethylolethane triglycidyl ether; 1,3-butadiene-diepoxide; 1,3-butadiene diepoxide; dicyclopentadiene dioxide; and methyl cis,cis-11,12,14,15-diepoxyeicosanoate.

14. The method of claim 11, further comprising adding an ethylenic monomer to the curable liquid.

15. The method of claim 14, wherein the ethylenic monomer is selected from a group consisting of methacrylamine; N-methylmethacrylamide; N-vinyl pyrrolidone; N-vinyl caprolactam; methacrylamidopropyl trimethylammonium chloride; and trimethylammoniumethyl methacrylate chloride.

16. The method of claim 11, further comprising adding a water soluble, free-radical generating catalyst.

17. The method of claim 1, wherein the step (a) comprises mixing a primary crosslinker with a secondary crosslinker, wherein the primary crosslinker comprises a crosslinked ionic monomer that comprises a quaternary ammonium group.

18. The method of claim 17, wherein the crosslinked ionic monomer is a product of mixing polyepoxide with a tertiary amine including an acrylic group in the presence of an acid.

19. The method of claim 17, wherein the primary crosslinked ionic monomer has the formula: 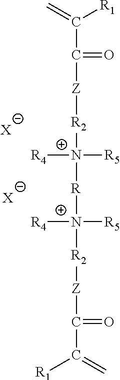
wherein:
R is —[CH₂—CH(OH)]₂—W;
R₁ is hydrogen or a C₁-C₁₂ alkyl group;
Z is oxygen or N—R₃; R₂ is —[CH₂]ₙ—;
R₃ is hydrogen or —[CH₂]ₘ—CH₃;
R₄ and R₅ are each, independently, —[CH₂]ₘ—CH₃;
X is selected from the group consisting of Cl, Br, I and acetate;
W is a bridging group or atom;
m is an integer from 0 to 20; and
n is an integer from 1 to 20.

20. The method of claim 17, wherein the secondary crosslinker is prepared by mixing an acrylamide compound with another acrylamide compound including hydroxyl groups.

21. The method of claim 1, further comprising (d) processing the membrane comprising conveying the membrane through at least two processing areas.

22. The method of claim 21, further comprising conveying the membrane precursor from a processing area for step (c) to a processing area for step (d).

23. The method of claim 22, further comprising conveying the substrate through processing areas for step (b) to the processing area for step (c).

24. The method of claim 21, wherein the step (d) further comprises extracting residues from the membrane and washing the membrane.

25. The method of claim 24, wherein, following the steps of extracting the residues from the membrane and washing the membrane, step (d) further comprises:
applying a dye to a first surface of the membrane;
feeding a contrast material adjacent a second surface of the membrane;
identifying dye marked regions of the contrast material; and
cutting the membrane.

26. The method of claim 1, wherein the aqueous solvent comprises water.
